(19) United States
(12) Patent Application Publication
(10) Pub. No.: US 2015/0154003 A1
(43) Pub. Date: Jun. 4, 2015

(54) BRAILLE IMPLEMENTATION IN TOUCH SENSITIVE TERMINAL

(71) Applicants: Ji-won KIM, Yongin-si (KR); Young Mi YOON, Busan (KR); Jin Hee YOO, Jecheon-si (KR)

(72) Inventors: Ji-won KIM, Yongin-si (KR); Young Mi YOON, Busan (KR); Jin Hee YOO, Jecheon-si (KR)

(21) Appl. No.: 14/466,230

(22) Filed: Aug. 22, 2014

(30) Foreign Application Priority Data
Aug. 22, 2013 (KR) 10-2013-0099397

(51) Int. Cl. G06F 3/16; G06F 3/0482; G06F 3/041

(52) U.S. Cl. CPC G06F 3/167; G06F 3/0416; G06F 3/0482

(57) ABSTRACT

Provided are a method and an apparatus for efficient Braille communication for vision-impaired people via a touch-sensitive terminal by providing a Braille keyboard environment via a touch display divided into 6 areas, determining an alphabet corresponding to a touch input with respect to at least one from among the 6 areas, displaying the determined alphabet, and outputting the determined alphabet into voice.

### CROSS-REFERENCE TO RELATED PATENT APPLICATION

This application claims the benefit of Korean Patent Application No. 10-2013-0099397, filed on Aug. 22, 2013 in the Korean Intellectual Property Office, the disclosure of which is incorporated herein in its entirety by reference.

### BACKGROUND OF THE INVENTION

1. Field of the Invention

The present invention relates to Braille input in a touch-sensitive terminal, and more particularly, to a method for conveniently and intuitively inputting conventional Braille in a touch-sensitive terminal.

2. Description of the Related Art

Based on the 2014 statistics report from WHO, there are about 285 million vision impaired people worldwide, where about 39 million people thereof are people with complete vision loss.

Each of countries employs Braille for vision-impaired people. However, even vision-impaired people strongly desire to use various IT devices.

Particularly, devices providing touch interfaces, such as smart phones and tablet PCs, still provide assistances such as a communication method via voice-recognition application for vision-impaired usersanj, but communication method familiar to vision-impaired people, e.g., Braille, are not provided yet. The application ‘ttalk,’ which is an application for exchanging voice messages in real time, is inevitably affected by ambient noises, and the application ‘Morse SNS,’ which is an application for exchanging text messages in the Morse codes, forces inconvenience of learning unfamiliar Morse codes to vision-impaired people.

### SUMMARY OF THE INVENTION

The present invention provides a method for efficient communication in a touch-sensitive terminal by using Braille.

According to an aspect of the present invention, there is provided a Braille communication method comprising dividing a touch display into at least 6 areas; sequentially receiving a touch input from at least one of the divided 6 areas; determining an alphabet corresponding to the received touch input; and displaying the determined alphabet on the touch display.

The Braille communication method further includes outputting the determined alphabet into voice.

The Braille communication further comprises, when a word is completed, receiving a first input for indicating the completed word.

The Braille communication method further comprises cancelling the determined alphabet as a second input is received.

The Braille communication method further comprises switching to an abbreviation input mode as a third input is received.

The Braille communication method further comprises outputting voice sound corresponding to the determined alphabet as a fourth input is received.

The Braille communication method further comprises when a designated area including center points of the 6 areas of the touch display is touched after a fifth input is received, generating a center point touch event.

According to another aspect of the present invention, there is provided a touch-sensitive terminal for Braille communication, the touch-sensitive terminal comprising a touch display providing a display screen configuration divided into at least 6 areas; a touch input receiving unit for sequentially receiving a touch input from at least one of the divided 6 areas; and a control unit for determining an alphabet corresponding to the received touch input, wherein the touch display displays the determined alphabet on the touch display.

The touch-sensitive terminal further comprises an output unit for outputting the determined alphabet into voice.

The center point touch event is a vibration or a sound output.

The first through fifth inputs are flicking inputs for sliding on a touch display or gesture inputs which are not simply tapping touches.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram showing an example of embodying Braille at a touch-sensitive terminal according to an embodiment of the present invention;

FIG. 2 is a diagram showing an example in which a touch screen of a touch-sensitive terminal is divided into 6 areas for Braille input, according to an embodiment of the present invention;

FIG. 3A-C are diagrams showing a table for matching Braille inputs to alphabets;

FIG. 4A-F are diagrams showing an input interface for embodying functions according to an embodiment of the present invention;

FIG. 5 is a block diagram of a touch-sensitive terminal for Braille communication according to an embodiment of the present invention; and

FIG. 6 is a flowchart showing a method for Braille communication according to an embodiment of the present invention.

### DETAILED DESCRIPTION OF THE INVENTION

The present invention will now be described more fully with reference to the accompanying drawings, in which exemplary embodiments of the invention are shown.

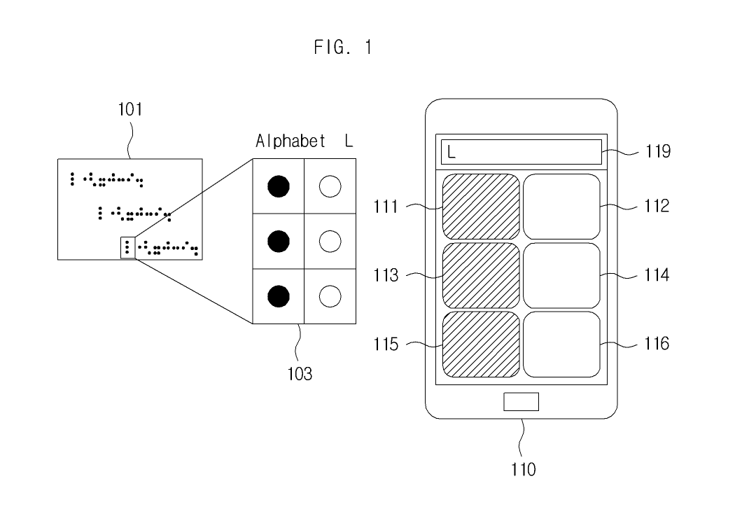

FIG. 1 is a diagram showing an example of embodying Braille at a touch-sensitive terminal according to an embodiment of the present invention.

Referring to FIG. 1, a Braille board 101 having protrusions thereon for general Braille is provided. As indicated by the reference numerals 101 and 103, a Braille board is generally divided into 6 areas, where the areas are arranged in 3 rows and 2 columns. A vision-impaired person may sense protrusions of the 6 areas and recognize a character based on the arrangement of protrusions. As shown in FIG. 1, if all areas in the left column protrude and all areas in the right column do not protrude, the Braille indicates an English alphabet ‘L.’ Of course, the corresponding Braille may indicate another alphabet or a word in a different language. For example, in case of Korean, the corresponding Braille indicates a word ‘ [symbol] (Sa).’

The reference numeral 110 indicates an example of embodying a Braille keyboard on a touch-sensitive terminal based on the idea that a Braille consists of 6 areas arranged in 2 columns. Hereinafter, for convenience of explanation, the arrangement as indicated by the reference numeral 110 in FIG. 1 will be referred to as ‘Braille keyboard.’

A display screen is divided into 6 areas 111, 113, 115, 112, 114, and 116 in correspondence to 6 areas for inputting a Braille as indicated by the reference numeral 103. When a user touches the areas 111, 113, and 115 in an order or within a designated time period, the touch-sensitive terminal recognizes the touch input as the alphabet ‘L.’ If a set language is not English, the touch input is recognized as an alphabet element or a word corresponding to a set language. It is not necessary for a user to touch the areas 111, 113, and 115 in a particular order, but it is necessary to touch the areas 111, 113, and 115 within a designated time period to distinguish one series of touch inputs corresponding to one alphabet from next series of touch inputs corresponding to another alphabet. A user may set a special input method to distinguish one alphabet input from a next alphabet input in advance. For example, a user may inform a touch-sensitive terminal completion of a single alphabet input by inputting a particular gesture or a flicking motion to the touch-sensitive terminal.

When a user touches one from among the six areas 111, 113, 115, 112, 114, and 116 for inputting Braille on a display screen of a touch-sensitive terminal 110, the touch-sensitive terminal 110 may inform the user of the normal touch input by vibration for every touch.

When the touch-sensitive terminal 110 recognizes touches on the areas 111, 113, and 115, the alphabet ‘L’ is displayed on a display screen 119, and the touch-sensitive terminal 110 outputs a voice indicating the alphabet 1′ in accordance with a setting of the touch-sensitive terminal. A vision-impaired person may recognize whether his/her current touch is normally input based on the voice.

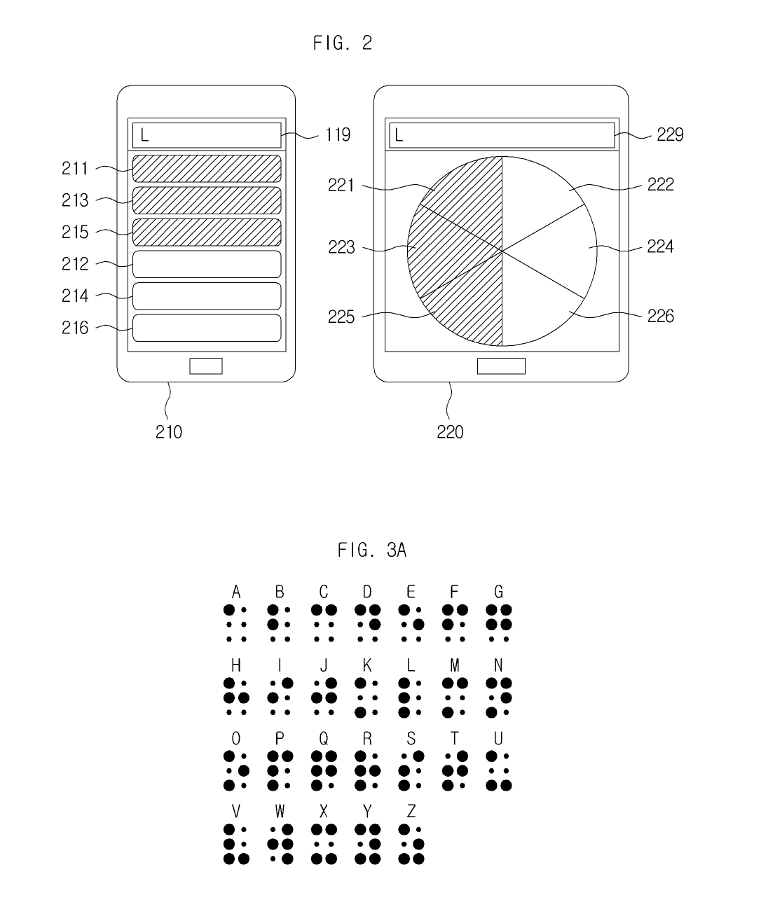

FIG. 2 is a diagram showing an example in which a touch screen of a touch-sensitive terminal is divided into 6 areas for Braille input, according to an embodiment of the present invention.

In consideration of a method of inputting Braille in the related art, a touch screen of a touch-sensitive terminal may be divided into the 6 areas as shown in FIG. 1. However, in consideration of convenience of interface, it is not necessary to divide a Braille input area into the arrangement as shown in FIG. For example, a touch-sensitive terminal 210 as shown in FIG. 2 shows an example that a Braille input area is divided into 6 vertically arranged areas. The three areas 111, 113, and 115 of the left column of the touch-sensitive terminal 110 may correspond to the upper 3 areas 211, 213, and 215 of the touch-sensitive terminal 210, whereas the three areas 112, 114, and 116 of the right column of the touch-sensitive terminal 110 may correspond to the lower 3 areas 212, 214, and 216 of the touch-sensitive terminal 210. However, the mapping configuration is described for convenience of explanation, and the mapping configuration may be reversed based on a user setting. Alternatively, the 3 areas in the left column of the touch-sensitive terminal 110 may correspond to the 3 areas 211, 215, and 214 of the touch-sensitive terminal 210, whereas the 3 areas in the right column of the touch-sensitive terminal 110 may correspond to the other 3 areas 213, 212, and 216 of the touch-sensitive terminal 210.

A touch-sensitive terminal 220 shows an example that a Braille input area is arranged as a circular area divided into areas. The 6 Braille input areas of the touch-sensitive terminal 220 includes a left semicircle including areas 221, 223, and 225 and a right semicircle including areas 222, 224, and 226. Intuitively, the 3 areas 111, 113, and 115 in the left column of the touch-sensitive terminal 110 may correspond to the areas 221, 223, and 225 of the left semicircle of the touch-sensitive terminal 220, whereas the 3 areas 112, 114, and 116 in the right column of the touch-sensitive terminal 110 may correspond to the areas 222, 224, and 226 of the right semicircle of the touch-sensitive terminal 220.

When position of the touch-sensitive terminal 220 is changed, the touch-sensitive terminal 220 may adaptively change the 6 areas. For example, if a user is holding the touch-sensitive terminal 220 upside down, functions of the left semicircle and the right semicircle may be reversed. In this case, if the touch-sensitive terminal 220 is held upside down, the touch-sensitive terminal 220 may change a setting, such that the 3 areas 111, 113, and 115 in the left column of the touch-sensitive terminal 110 correspond to the areas 226, 224, and 222 of the right semicircle of the touch-sensitive terminal 220 and the 3 areas 112, 114, and 116 in the right column of the touch-sensitive terminal 110 correspond to the areas 225, 223, and 221 of the left semicircle of the touch-sensitive terminal 220.

Such a change of setting may be applied to the touch-sensitive terminal 110.

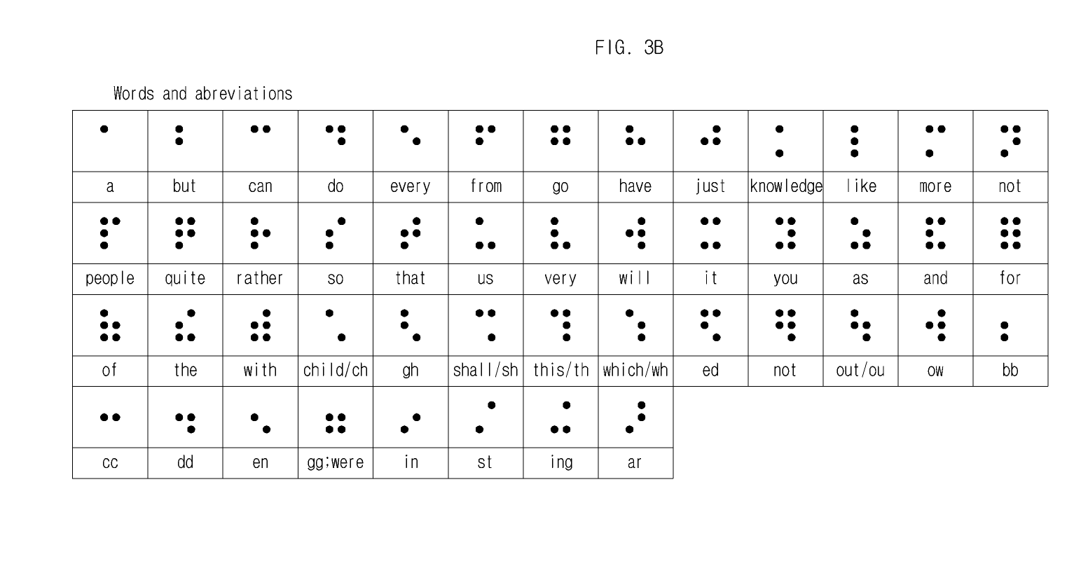

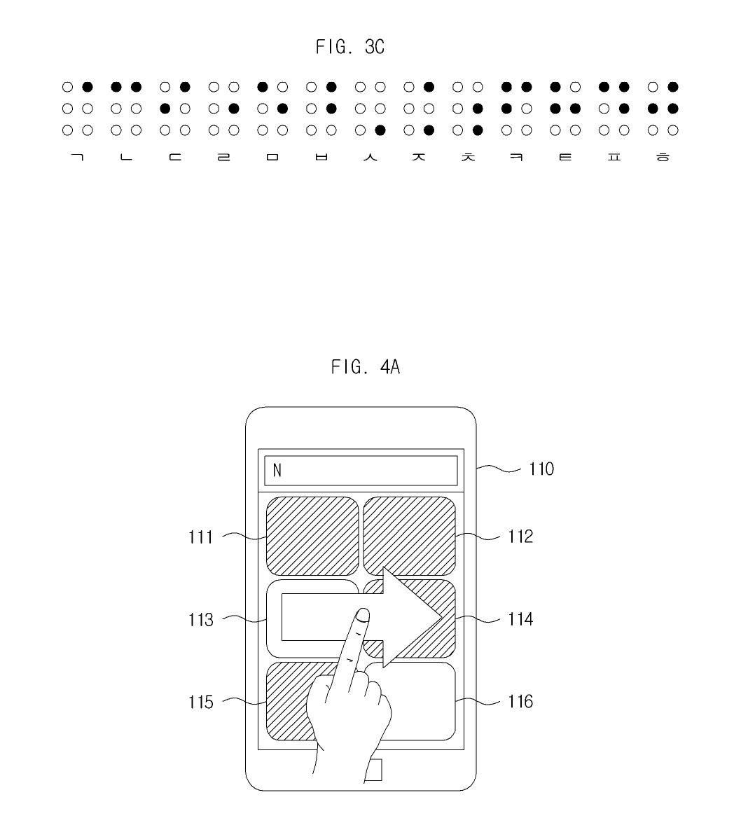

FIG. 3 is a diagram showing a table for matching Braille inputs to alphabets.

FIG. 3A is a table for matching Braille inputs to English alphabets.

FIG. 3B is a table for matching Braille inputs to English abbreviations. As shown in FIG. 3B, a word or a preposition that is used commonly and frequently may be input via single Braille inputs. In languages other than English, an everyday word is often input via a single Braille input.

FIG. 3C shows an example of Braille inputs corresponding to consonants of Korean alphabet.

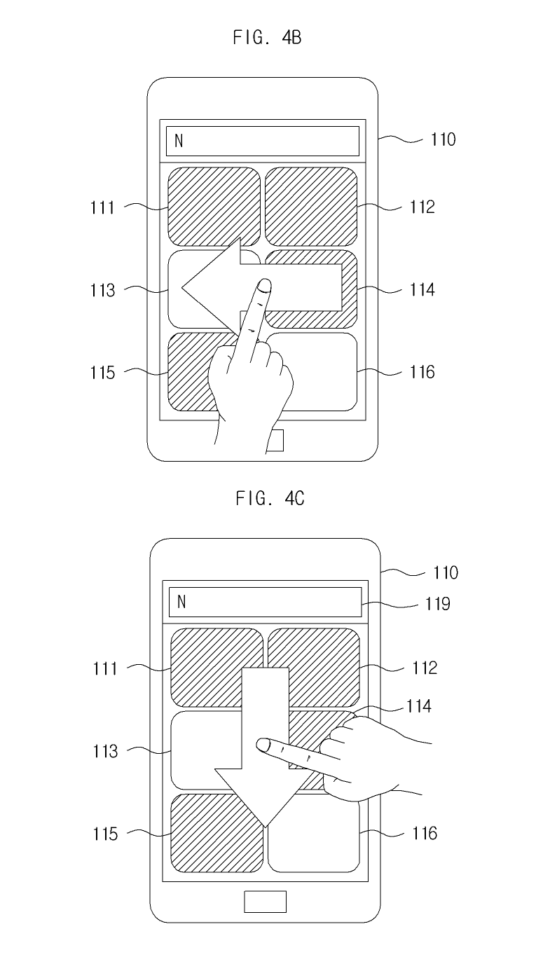

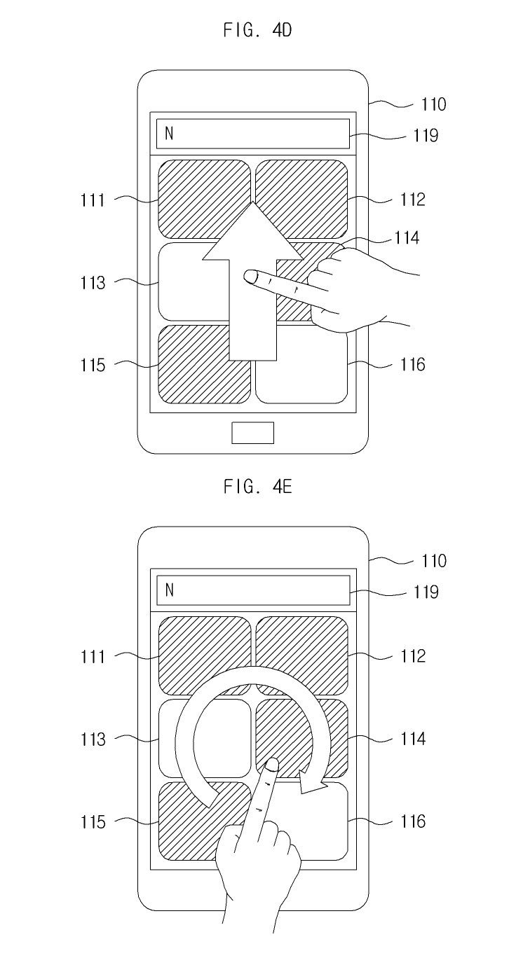

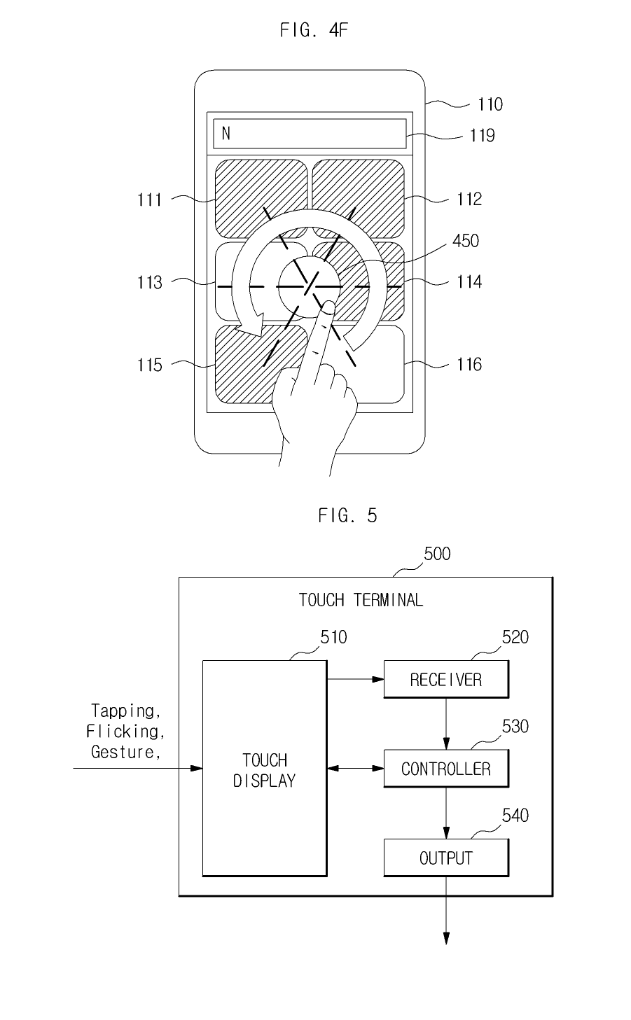

FIG. 4 is a diagram showing an input interface for embodying functions according to an embodiment of the present invention.

In case of inputting a Braille onto the touch-sensitive terminal 110, various functions other than Braille recognition via basic Braille input touches are required. Touch inputs performed on the touch-sensitive terminal 110 may include a tapping for simply touching a touch display, a flick for sliding on a touch display, a gesture comprising a plurality of touches, etc. Touching a Braille keyboard on the touch-sensitive terminal 110 may be embodied with tapping. Various other functions are required for inputting Braille, where such functions may be embodied with flicks or gestures.

FIG. 4A shows an example of a left-to-right flick for spacing between words generated by touching a Braille keyboard, according to an embodiment of the present invention.

In FIG. 4A, when the English alphabet ‘N’ is input via a Braille keyboard, a user flicks from left to right. The touch-sensitive terminal 110 recognizes a flicking input that a user touches the areas 113 and 114 within a short time period as a spacing input. Alternatively, a user may set such a flicking input as an input for distinguishing one alphabet input from another.

FIG. 4B shows an example of a right-to-left flick for deleting a word generated by touching a Braille keyboard, according to an embodiment of the present invention.

In FIG. 4B, when the English alphabet ‘N’ is input via a Braille keyboard, a user flicks from right to left. The touch-sensitive terminal 110 receives the flicking input of the user, recognizes a user's intent of deleting a currently input word, and deletes the input alphabet ‘N.’

FIG. 4C shows an example of an up-to-down flick for confirming a word generated by touching a Braille keyboard, according to an embodiment of the present invention.

In FIG. 4C, when the English alphabet ‘N’ is input via a Braille keyboard, a user flicks from up to down. The touch-sensitive terminal 110 receives the flicking input of the user and recognizes the flicking input as an enter input for finalizing a currently input word. If the enter input is set as a transmission of an input word, the entire sentence displayed on the display screen 119 will be transmitted. Of course, the enter input may be set as a transmission in conjunction of a text-message application. However, based on types of applications, an enter input may be recognized otherwise.

FIG. 4D shows an example of a down-to-up flick for switching input mode of a Braille keyboard to abbreviation input (or recognition) mode, according to an embodiment of the present invention.

In FIG. 4D, when the English alphabet ‘N’ is input via a Braille keyboard, a user flicks from down to up. The touch-sensitive terminal 110 receives the flicking input of the user and switches a current alphabet character input mode to an abbreviation input mode. Although Braille input patterns of alphabet characters and abbreviations may be set not to interfere each other, a separate abbreviation input mode may be set if a user wants to input various abbreviation. If a user flicks from down to up once again, the touch-sensitive terminal 110 switches from the abbreviation input mode back to the alphabet character input mode. Based on the user's selection, the abbreviation input mode may be named as an everyday word input mode.

FIG. 4E shows an example of a clockwise flick for outputting a currently input text generated by touching a Braille keyboard into voice, according to an embodiment of the present invention.

In FIG. 4E, when the English alphabet ‘N’ is input via a Braille keyboard, a user flicks clockwise in a circular shape. The touch-sensitive terminal 110 receives the flicking input of the user and outputs words or a sentence displayed on the display screen 119 so far into voice. Therefore, if a user is a vision-impaired person, the user may frequently input clockwise flicks to confirm a text input so far.

FIG. 4F shows an example of a counterclockwise flick for confirming the center point of a Braille keyboard, according to an embodiment of the present invention.

In FIG. 4, since a user is generally a vision-impaired person, the user needs to confirm where the center point of a Braille keyboard is. To this end, the user flicks counterclockwise in a circular shape on the touch display of the touch-sensitive terminal 110. As a result, the touch-sensitive terminal 110 is switched to a center point confirmation mode. The user touches an area estimated as the center point of the touch-sensitive terminal 110. Here, if the user touches a designated center area 450, the touch-sensitive terminal 110 generates a designated event that may be recognized by the user. Therefore, the user confirmed where the center point is again. The user may return to a previous mode, which is an alphabet character input mode or an abbreviation input mode, by flicking counterclockwise in a circular shape on the touch display of the touch-sensitive terminal 110 again. He the designated event that may be recognized by the user may be a vibration of the touch-sensitive terminal 110 or a sound output. The user may recognize that the center point is found by recognizing a vibration or a sound.

The flicking inputs as described above are not necessarily mapped to the corresponding functions and function mappings therebetween may be changed based on a user convenience. Furthermore, the leftward, rightward, upward, and downward flicks, the clockwise flick, and the counterclockwise flick may be replaced with other types of gestures. For example, gestures that may replace the flicks to perform the above-stated functions may include zoom-in, zoom-out, combinations with the zoom-in and the zoom-out with any of upward, downward, leftward, and rightward touch and/or rotation during a multi-touch. Alternatively, a multi-tap may replace the flicks. For example, if a Braille keyboard receives only one input at a time, combinations of two to five simultaneous touches may be mapped to one of the above-stated functions.

FIG. 5 is a block diagram of a touch-sensitive terminal 500 for Braille communication according to an embodiment of the present invention.

A touch display 510 provides a Braille keyboard divided into 6 areas for Braille communication according to an embodiment of the present invention. The touch display 510 detects touch inputs from a user including taps, flicks, gestures, and multi-taps, and the receiving unit 520 distinguishes and recognizes the respective touch inputs. Based on an input received by the receiving unit 520, if the input includes taps on the Braille keyboard, the control unit 530 determines an alphabet character, an abbreviation, or an everyday word mapped to the taps. Although not shown, a database for mapping alphabet characters, abbreviations, or everyday words may be stored in the touch-sensitive terminal 500. An alphabet character, an abbreviation, or an everyday word determined by the control unit 530 is displayed on the touch display 510. If an input received by the receiving unit 520 is not a tap and is a flick, a gesture, or a multi-tap, the control unit 530 embodies a function mapped to the input. For example, based on the types of flicks as described above, the control unit 530 performs functions including spacing, deleting, switching to an abbreviation or everyday word input mode, instructing to output displayed alphabet(s) into voice, switching to a center point confirming mode, etc.

An output unit 540 performs voice output function based on a voice output instruction from the control unit 530.

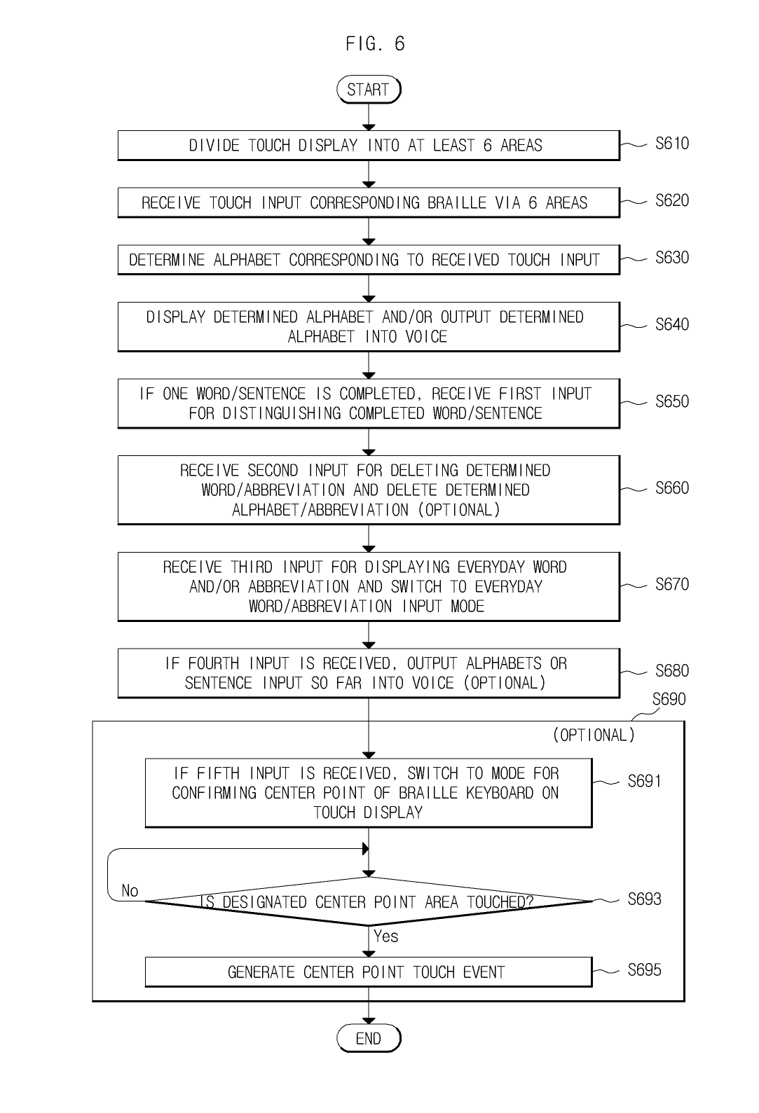

FIG. 6 is a flowchart showing a method for Braille communication according to an embodiment of the present invention.

A touch display of a touch-sensitive terminal is divided into at least 6 areas (operation S610). An area for inputting Braille may be divided into 6 areas.

A user touches on a Braille keyboard generated by dividing the touch display into 6 areas (operation S620). When a touch input is made onto the Braille keyboard, the touch-sensitive terminal refers to a database stored in an internal memory and determines an alphabet mapped to the corresponding input on the Braille keyboard (operation S630). The touch-sensitive terminal may display the determined alphabet on a display unit of the touch-sensitive terminal and/or output the determined alphabet into voice (operation S640).

When a word or a sentence is completed, the touch-sensitive terminal receives a first input for distinguish the completed word or sentence (operation S650). To be distinguished from a general touch input on the Braille keyboard, the first input may be one from among a flick, a gesture, or a multi-tap.

If a selectively determined alphabet or abbreviation is not an alphabet or abbreviation intended by a user, the user may delete the determined alphabet or abbreviation by inputting a flick, a gesture, or a multi-tap corresponding to a second input (operation S660).

A user may also switch from an alphabet character input mode to an every data word or abbreviation input mode by inputting a flick, a gesture, or a multi-tap corresponding to a third input (operation S670).

A user may output an alphabet or a sentence displayed on the touch-sensitive terminal before a fourth input by inputting a flick, a gesture, or a multi-tap corresponding to the fourth input (operation S680)

As described above, the user is a vision-impaired person, and thus the user needs to frequently confirm the center point of the Braille keyboard. In this case, an operation S690 may be selectively performed.

First, the user may switch an alphabet character input mode or an every data word input mode to a Braille keyboard's center point confirmation mode by inputting a flick, a gesture, or a multi-tap corresponding to a fifth input (operation S691). When the touch-sensitive terminal is switched to the Braille keyboard's center point confirmation mode, the user finds an area corresponding to the center point and repeatedly inputting taps. Here, if an area tapped by the user does not correspond to a designated center point area, the touch-sensitive terminal requests the user to continuously input taps (operation S693). If an area tapped by the user corresponds to the designated center point area, the touch-sensitive terminal generates an event informing that the designated center point is found (operation S695).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A Braille communication method comprising:
dividing a touch display into at least 6 areas;
sequentially receiving a touch input from at least one of the divided 6 areas;
determining an alphabet corresponding to the received touch input; and
displaying the determined alphabet on the touch display.

2. The Braille communication method of claim 1, further comprising outputting the determined alphabet into voice.

3. The Braille communication method of claim 1, further comprising, when a word is completed, receiving a first input for indicating the completed word.

4. The Braille communication method of claim 1, further comprising:
cancelling the determined alphabet as a second input is received.

5. The Braille communication method of claim 1, further comprising:
switching to an abbreviation input mode as a third input is received.

6. The Braille communication method of claim 1, further comprising:
outputting voice sound corresponding to the determined alphabet as a fourth input is received.

7. The Braille communication method of claim 1, further comprising:
when a designated area comprising center points of the 6 areas of the touch display is touched after a fifth input is received, generating a center point touch event.

8. A touch-sensitive terminal for Braille communication, the touch-sensitive terminal comprising:
a touch display providing a display screen configuration divided into at least 6 areas;
a touch input receiving unit for sequentially receiving a touch input from at least one of the divided 6 areas; and
a control unit for determining an alphabet corresponding to the received touch input,
wherein the touch display displays the determined alphabet on the touch display.

9. The touch-sensitive terminal of claim 8, further comprising an output unit for outputting the determined alphabet into voice.

10. The touch-sensitive terminal of claim 8, wherein, when a word is completed, the touch input receiving unit receives a first input for distinguishing the completed word.

11. The touch-sensitive terminal of claim 8, wherein the touch input receiving unit receives a second input for deleting the determined alphabet, and
the control unit deletes the determined alphabet.

12. The touch-sensitive terminal of claim 8, wherein the touch input receiving unit receives a third input for displaying an abbreviation, and
the control unit switches to an abbreviation input mode as the third input is received.

13. The touch-sensitive terminal of claim 9, wherein the touch input receiving unit receives a fourth input, and
the output unit outputs alphabets input before the reception of the fourth input into voice as the fourth input is received.

14. The touch-sensitive terminal of claim 9, wherein the touch input receiving unit receives a fifth input, and,
when a designated area comprising center points of at least the 6 areas of the touch display is touched after the fifth input is received, the output unit generates a center point touch event.

15. The touch-sensitive terminal of claim 14, wherein the center point touch event is a vibration or a sound output.

16. The touch-sensitive terminal of claim 10, wherein the first input is one from among a flicking input, a gesture input, and a multi-tapping input.
